(19) United States
(12) Patent Application Publication
(10) Pub. No.: US 2019/0136912 A1
(43) Pub. Date: May 9, 2019

(54) METHOD FOR SETTING CORRECT ROLLER BEARING CLEARANCE

(71) Applicant: Peerless-Winsmith, Inc., Springfield, NY (US)

(72) Inventors: Stephen Dunlap, Orchard Park, NY (US); Robert A. Geiser, Elma, NY (US); Phil Gott, Gainesville, GA (US); Robert N. Holdsworth, East Aurora, NY (US); Abraham B. McClellan, Springville, NY (US); Mark Perkins, Collins, NY (US)

(21) Appl. No.: 16/180,383

(22) Filed: Nov. 5, 2018

Related U.S. Application Data
(60) Provisional application No. 62/581,082, filed on Nov. 3, 2017.

(51) Int. Cl. F16C 43/06; F16C 19/36; F16C 33/36

(52) U.S. Cl. CPC F16C 43/06; F16C 2361/61; F16C 33/366; F16C 19/364

(57) ABSTRACT

A method of setting the clearance of a tapered roller bearing assembly of the type having a housing with an access opening, and in which housing is positioned an input shaft engaging a worm or gears for driving an output gear engaging an output shaft mounted on a bearing assembly for transmitting power. The method includes the steps of first tightening a removable cover in the housing to a point in contact with the bearing assembly and having a predetermined torque value, and thereafter backing the cover away from the bearing assembly by a distance calculated by the following formula: End play setting angle in degrees=(360 degrees)×(Clearance constant)×(Desired bearing clearance in inches)/(Thread pitch in inches). This method achieves a correct clearance setting defined by the end play setting angle in degrees where the cover is rotated by the number of degrees in the end play setting angle to reduce the predetermined torque value. The last step is to lock the cover in a position that defines the correct clearance setting.

### CROSS REFERENCE TO RELATED PATENT APPLICATIONS

This application expressly incorporates by reference, and claims the benefit of and priority to U.S. Provisional Application having Ser. No. 62/581,082 filed on Nov. 3, 2017

### TECHNICAL FIELD AND BACKGROUND OF THE INVENTION

This invention relates to a method for setting the correct clearance of tapered roller bearings. The particular disclosure of this application relates to a roller bearing for a gear reducer, but the scope of the invention is not limited to this specific structure.

Gear reducers are gear trains between a motor and a piece of machinery. Gear reducers, much as the name implies, reduce the rpm output of the input motor so that the output rpm of the gear reducer is the correct speed for the particular application. Gear reducers also take the torque created by the input motor and increase it. Many gear reducers are “right angle drive”, meaning that the design permits the axis of rotation of an output shaft to be 90 degrees from the axis of rotation of an input shaft. There are many right angle gear reducer designs, including designs that use a threaded input worm engaging a toothed output gear wheel.

Gear reducers are high precision devices with very close tolerances. Each device is slightly different due to manufacturing/machining tolerances associated with multiple interacting tolerances of, for example, tapered roller bearings. Improperly adjusted bearings can lead to increased wear, reduced life and excess friction-generated heat. A typical bearing clearance tolerance range is 0.001″-0.004″ or about the thickness of a sheet of paper.

The prior art method for adjusting tolerances to the correct setting is to use multiple, very thin shims or gaskets. This process requires substantial labor and is time consuming. Typically, this prior art clearance setting process involves repeatedly assembling, measuring, disassembling, adjusting, reassembling and readjusting the gear reducer until the correct setting is achieved.

A more effective, accurate and efficient method of setting the tapered roller bearing clearance in a gear reducer is therefore desirable.

### SUMMARY OF THE INVENTION

It is therefore an object of the present invention to provide a method of setting a tapered roller bearing clearance.

It is another object of the present invention to provide a method that allows an effective, accurate and efficient setting of a correct clearance of gear reducer tapered roller bearings.

It is another object of the present invention to provide a method that allows an effective, accurate and efficient setting of a correct clearance of gear reducer tapered roller bearings without disassembling an already assembled gear reducer.

These and other objects and advantages of the present invention are achieved in the preferred embodiments set forth below by providing a method of setting the clearance of a tapered roller bearing assembly of the type having a housing with an access opening, and in which housing is positioned an input shaft engaging a worm or gears for driving an output gear engaging an output shaft mounted on a bearing assembly for transmitting power. The method includes the steps of first tightening a removable cover in the housing to a point in contact with the bearing assembly and having a predetermined torque value, and thereafter backing the cover away from the bearing assembly by a distance calculated by the following formula: End play setting angle in degrees=(360 degrees)×(Clearance constant)×(Desired bearing clearance in inches)/(Thread pitch in inches). This method achieves a correct clearance setting defined by the end play setting angle in degrees where the cover is rotated by the number of degrees in the end play setting angle to reduce the predetermined torque value. The last step is to lock the cover in a position that defines the correct clearance setting.

According to another embodiment, the clearance constant is determined by the following steps: determining a predetermined optimum desired bearing clearance, determining empirically an end play setting angle in degrees for the desired bearing clearance, determining a predetermined thread pitch, and then insert the values into the formula and solve for the clearance constant.

According to another embodiment, the step of locking the cover in position is performed by a thread-locking fluid.

According to another embodiment, the roller bearing assembly is a component of a gear reducer.

According to another embodiment, the step of locking the cover in position is performed by the following steps: drilling and tapping a hole in the backed away cover position and installing a threaded fastener in the hole.

According to another embodiment, the step of tightening the cover is performed to a predetermined torque of approximately 25 in/lbs.

According to another embodiment, a method is provided for setting the clearance of a tapered roller bearing assembly of the type having a housing with an access opening, and in which housing is positioned an input shaft engaging a worm or gears for driving an output gear engaging an output shaft mounted on a bearing assembly for transmitting power. The method includes the steps of first tightening a removable cover in the housing to a point in contact with the bearing assembly and having a predetermined torque value, and thereafter determining a clearance constant by defining values for a predetermined optimum desired bearing clearance, an empirically determined end play setting angle in degrees for the desired bearing clearance, and a predetermined thread pitch and inserting the defined values into the following clearance constant formula: Clearance constant=(Empirically determined end play setting angle in degrees×Predetermined thread pitch in inches)/(360 degrees×Optimum desired bearing clearance). Then next backing the cover away from the bearing assembly by a distance calculated by the following formula: End play setting angle in degrees=(360 degrees)×(Clearance constant)×(Desired bearing clearance in inches)/(Thread pitch in inches). Application of these method steps achieve a correct clearance setting defined by the end play setting angle in degrees where the cover is rotated by the number of degrees in the end play setting angle to reduce the predetermined torque value. The last step is to lock the cover in a position that defines the correct clearance setting.

According to another embodiment, further including the step of painting the locked cover with an enamel or epoxy paint to further lock the cover in position.

### BRIEF DESCRIPTION OF THE DRAWING FIGURES

The present invention is best understood when the following detailed description of the invention is read with reference to the accompanying drawings, in which:

FIG. 1 is a vertical plan view cross-section of a gear reducer of the type suitable for use of the clearance setting method of the invention, with the cover in a fully-detached position;

FIG. 2 is a vertical plan view cross-section of the gear reducer of FIG. 1 with the cover in a partially-seated position;

FIG. 3 is a vertical plan view cross-section of the gear reducer of FIG. 1 with the cover in a fully-seated position;

FIG. 4 is a perspective cross-section of the gear reducer of FIGS. 1, 2 and 3 with the cover in the fully-seated position of FIG. 3; and

FIG. 5 is a flow chart illustrating a method of carrying out the invention according to one preferred embodiment.

### DETAILED DESCRIPTION OF THE PREFERRED EMBODIMENT

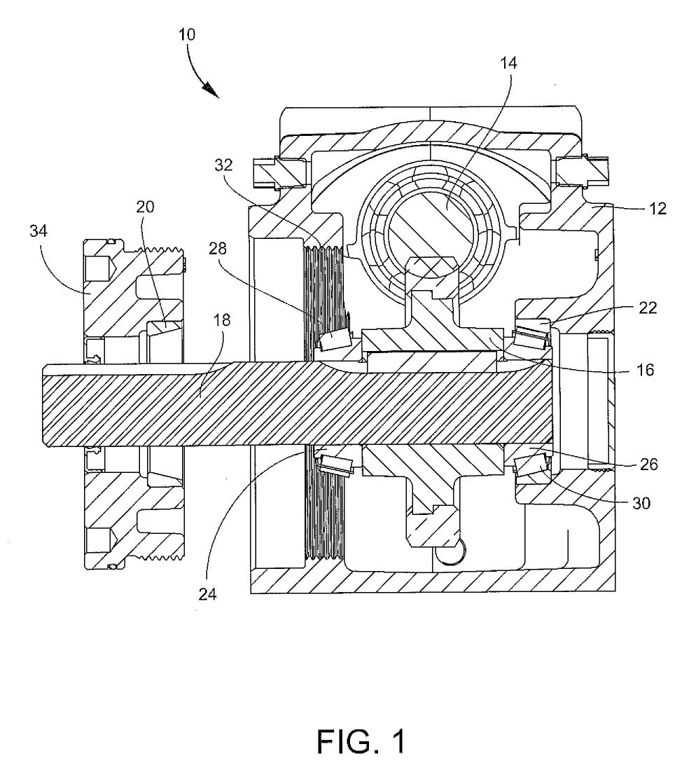

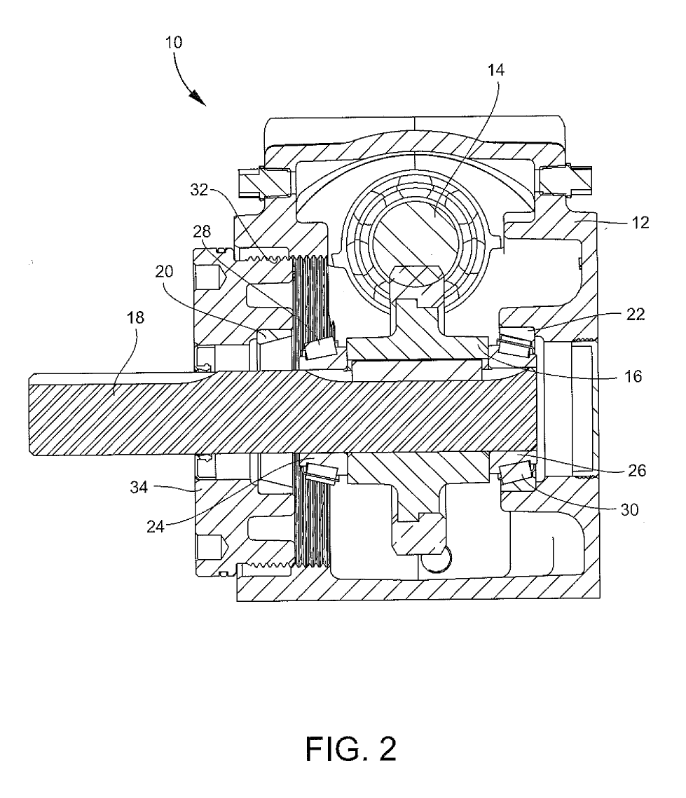

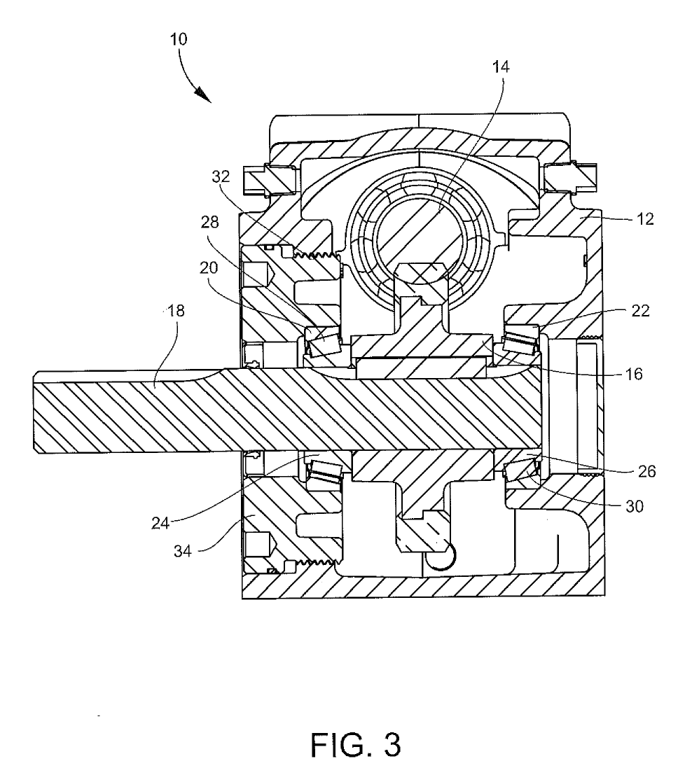

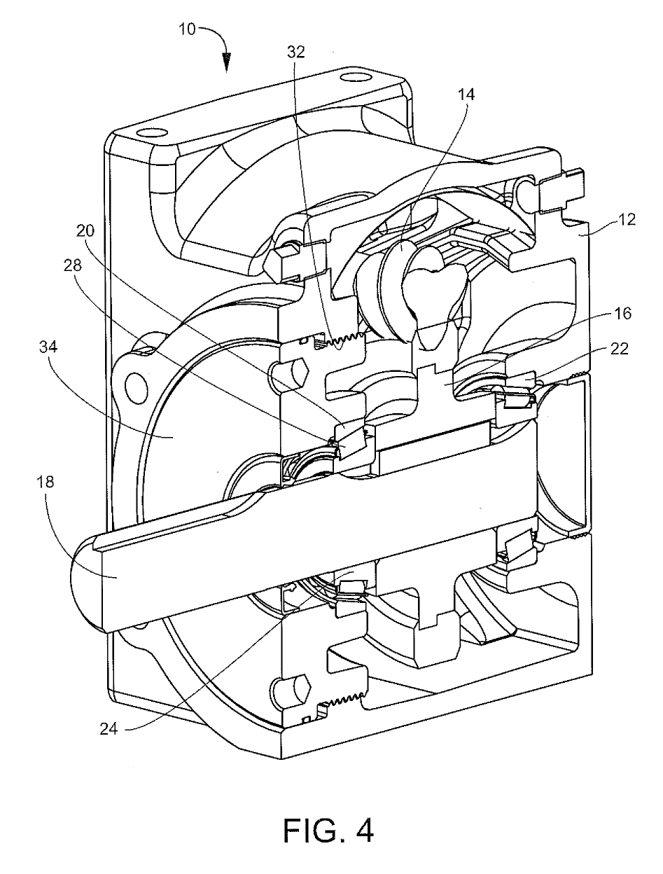

Referring now to FIGS. 1-4, a gear reducer 10 includes a housing 12 in which is mounted an input gear, such as the shown worm 14 that engages and transfers rotation to an output gear wheel mounted on an output shaft 18. Tapered bearing cups 20, 22 are mounted in a cover 34 and housing 12 surrounding the output shaft 18. Complementary bearing cones 24, 26 are mounted on the output shaft 18, with roller bearings 28, 30 mounted for rotation between the bearing cups 20, 22 and the bearing cones 24, 26. The bearing cups 20, 22, bearing cones 24, 26 and roller bearings 28, 30 collectively form the roller bearing assembly.

The housing 12 includes a threaded access opening 32 adapted to receive a threaded cover 34. The output shaft 18 extends through the cover 34 and/or housing 12.

To correctly set the bearing clearance, the cover 34 is threaded into the access opening 32 until the cover 34 is tight against the roller bearing 28. The cover 34 is then unscrewed slightly to back the cover 34 away from the roller bearing 28 by a small calculated amount representing the correct clearance setting. With the cover 34 in this position, a thread locker, for example, a suitable Loctite® or Permatex® product, is applied to fix the cover 34 in the correct position.

Optionally, the gear reducer 10 may be painted with an enamel or epoxy paint to further lock the cover 34 in place and to resist unscrewing of the cover 34 during operation-induced vibration.

Optionally, a pressed pin or threaded fastener may be used to lock the cover in place rotationally. This pin/fastener would be installed into a hole that is located and drilled/tapped after the bearing clearance is set.

The distance that the cover 34 is backed away from the roller bearing 28 to set the correct clearance is determined by first tightening the cover 34 into the roller bearing 28 to a predetermined torque of approximately 25 in/lbs. This value is considered sufficient to limit any movement of the cover 34 in relation to the other components without damaging the roller bearing assembly. To set the correct position of the cover 34, referred to as the “end play setting angle”, the following calculation takes place:

End play setting angle in degrees=(360 degrees)×(Clearance constant)×(Desired bearing clearance in inches)/(Thread pitch in inches). The “clearance constant” is a value that takes into account the axial play in the threaded access opening 32 and in the bearing assembly. The clearance constant can be determined in the above calculation by determining an optimum desired bearing clearance, determining empirically an end play setting angle in degrees for the desired bearing clearance, inserting those values into the calculation and then solving for “clearance constant.”

By way of example, if the thread pitch is 0.063 in., the clearance constant is 2 and the desired bearing clearance is 0.003 in., the cover setting angle (end play setting angle) calculates to 34 degrees, thus:

End play setting angle=(360×2×0.003)/(0.063)=34 degrees.

Accordingly, the cover 34 will be rotated back 34 degrees from its properly torqued position, leaving the desired clearance between the cover 34 and the roller bearing 28 of 0.003″.

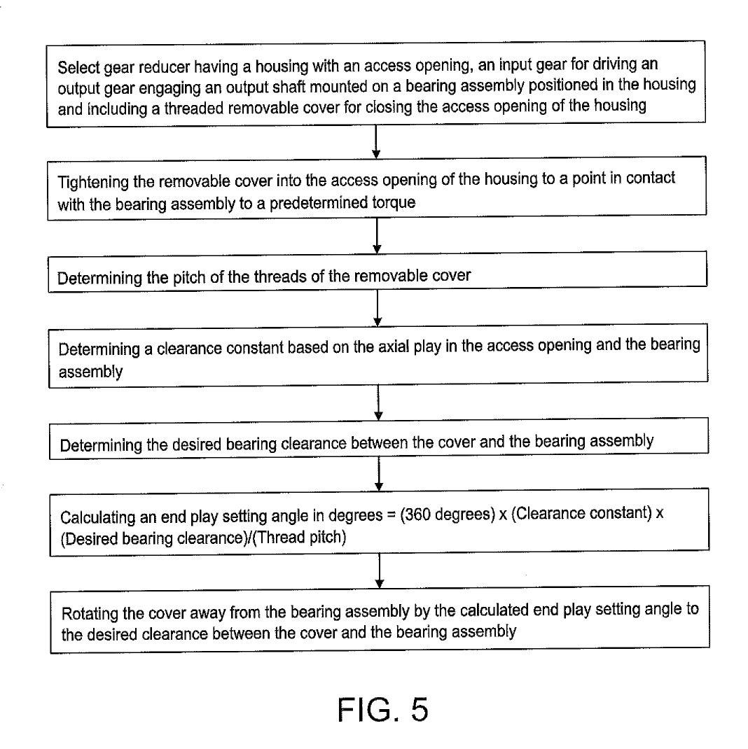

The method of the invention is summarized in FIG. 5.

A method for setting the correct clearance of tapered roller bearings in a gear reducer and a gear reducer that has a clearance setting feature that permits easy and quick setting of the correct clearance of such roller bearings according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

We claim:

1. A method of setting the clearance of a tapered roller bearing assembly of the type having a housing with an access opening, and in which housing is positioned an input shaft engaging a worm or gears for driving an output gear engaging an output shaft mounted on a bearing assembly for transmitting power, and including the steps of:
(a) tightening a removable cover in the housing to a point in contact with the bearing assembly and having a predetermined torque value;
(b) backing the cover away from the bearing assembly by a distance calculated by the following formula:
End play setting angle in degrees=(360 degrees)×(Clearance constant)×(Desired bearing clearance in inches)/(Thread pitch in inches)
to achieve a correct clearance setting defined by the end play setting angle in degrees where the cover is rotated by the number of degrees in the end play setting angle to reduce the predetermined torque value; and
(c) locking the cover in the position defining the correct clearance setting.

2. A method according to claim 1, wherein the clearance constant is determined by the following steps:
(a) determining a predetermined optimum desired bearing clearance;
(b) determining empirically an end play setting angle in degrees for the desired bearing clearance;
(c) determining a predetermined thread pitch; and
(d) inserting the values from (a)-(c) into the formula and solving for the clearance constant.

3. A method according to claim 1, wherein the step of locking the cover in position is performed by a thread-locking fluid.

4. A method according to claim 1, wherein the roller bearing assembly is a component of a gear reducer.

5. A method according to claim 1, wherein the step of locking the cover in position is performed by the following steps:
(a) drilling and tapping a hole in the backed away cover position; and
(b) installing a threaded fastener in the hole.

6. A method according to claim 1, wherein the step of tightening the cover is performed to a predetermined torque of approximately 25 in/lbs.

7. A method of setting the clearance of a tapered roller bearing assembly of the type having a housing with an access opening, and in which housing is positioned an input shaft engaging a worm or gears for driving an output gear engaging an output shaft mounted on a bearing assembly for transmitting power, and including the steps of:
(a) tightening a removable cover in the housing to a point in contact with the bearing assembly and having a predetermined torque value;
(b) determining a clearance constant by defining values for a predetermined optimum desired bearing clearance, an empirically determined end play setting angle in degrees for the desired bearing clearance, and a predetermined thread pitch and inserting and inserting the defined values into the following clearance constant formula:
Clearance constant=(Empirically determined end play setting angle in degrees×Predetermined thread pitch in inches)/(360 degrees×Optimum desired bearing clearance);
(c) backing the cover away from the bearing assembly by a distance calculated by the following formula:
End play setting angle in degrees=(360 degrees)×(Clearance constant)×(Desired bearing clearance in inches)/(Thread pitch in inches)
to achieve a correct clearance setting defined by the end play setting angle in degrees where the cover is rotated by the number of degrees in the end play setting angle to reduce the predetermined torque value; and
(d) locking the cover in the position defining the correct clearance setting.

8. A method according to claim 7, wherein the step of locking the cover in position is performed by a thread-locking fluid.

9. A method according to claim 7, wherein the roller bearing assembly is a component of a gear reducer.

10. A method according to claim 7, wherein the step of locking the cover in position is performed by the following steps:
(a) drilling and tapping a hole in the backed away cover position; and
(b) installing a threaded fastener in the hole.

11. A method according to claim 7, wherein the step of tightening the cover is performed to a predetermined torque of approximately 25 in/lbs.

12. A method according to claim 7, further comprising the step of painting the locked cover with an enamel or epoxy paint to further lock the cover in position.
